(19) United States
(12) Patent Application Publication
(10) Pub. No.: US 2014/0195422 A1
(43) Pub. Date: Jul. 10, 2014

(54) DIGITAL WALLET CLIENT DEVICE

(71) Applicants: Yu ZHENG, City of Industry, CA (US); Felix SUI, Irvine, CA (US)

(72) Inventors: Yu ZHENG, City of Industry, CA (US); Felix SUI, Irvine, CA (US)

(73) Assignee: Patent Category Corporation, Walnut, CA (US)

(21) Appl. No.: 13/737,712

(22) Filed: Jan. 9, 2013

(51) Int. Cl. G06Q 20/36

(52) U.S. Cl. CPC G06Q 20/36
USPC 705/41

(57) ABSTRACT

A digital wallet serves as a virtual wallet for all of the credit cards of a user. The digital wallet can be extended to other types of spending cards. Spending limits can be set for individual cards, as well as global limits. The user may setup an eCard on behalf of a recipient, where the eCard has a spending limit and the master account can view eCard transactions. Digital receipt management is provided to aid a user to organize receipts. Techniques to use a temporary code to improve the security of verifying a user is also disclosed.

The present application is related to the following commonly assigned, co-pending U.S. patent applications, filed concurrently herewith, for DIGITAL WALLET SERVER (application Ser. No. ______; Attorney docket no. AZOOP001); for DIGITAL WALLET INCLUDING VENDING AND PAYMENT RECEIPT FUNCTIONS (application Ser. No. ______; Attorney docket no. AZOOP003); and for MULTIFUNCTION DIGITAL WALLET SERVICE INCLUDING IDENTIFICATION AND PAYMENT RECEIPT (application Ser. No. ______; Attorney docket no. AZOOP004). The above-listed applications are all incorporated herein by reference in their entirety for all purposes.

### FIELD OF THE INVENTION

The present invention is generally related to digital wallet technology. More particularly, the present invention is directed to improvements in digital wallet technology.

### BACKGROUND OF THE INVENTION

A digital wallet (also known as an e-wallet) is used to store various forms of electronic money and store resources to aid in making e-commerce transactions. A digital wallet may be implemented on a portable wireless client device, such as a smart phone, with additional server-side support.

The widespread adoption of digital wallets has been slower than many industry observers expected. One problem is consumer concern about security. Another problem is that digital wallets have not previously offered enough compelling services. In particular, previous digital wallet approaches have not provided a comprehensive solution to the problems faced by consumers.

Therefore, what is desired are improved services, ease of use, and security mechanisms for digital wallets.

### SUMMARY OF THE INVENTION

A digital wallet client device, digital wallet server, methods of use, and a non-transitory computer readable medium, are disclosed. A digital wallet permits a user to select a credit card, or use a set of credit cards, in order to make a payment. Additionally, other digital wallet functions may be provided in selected embodiments. In one embodiment, the digital wallet function may be provided for other spending related cards, including debit cards and discount cards. In one embodiment, a virtual credit card function may be provided to provide funds from a master account to a recipient account. In one embodiment, a digital photo ID function may be provided to provide a verification function. In one embodiment, consumer may also optionally set spending limits on individual credit cards or on sets of credit cards. In one embodiment, a temporary time sensitive code may be generated and provided to a client device. In one embodiment, digital receipt management is provided. In one embodiment, recommendations are provided for optimizing use of credit cards. In one embodiment, fund management is provided. In one embodiment, a digital official ID is provided. In one embodiment, links to banks and credit cards are provided such that a digital wallet service acts as a middleman to aid a consumer to manage payments and fund transfers. In one embodiment, an individual client device cannot only make payments, it can also receive payments from other client devices, and thus, also act as a vending device. In one embodiment, a social networking function is supported such that a consumer can send or receive payments from friends in a social network.

### BRIEF DESCRIPTION OF THE DRAWINGS

FIG. 1 is a high level block diagram illustrating an exemplary set of features provided to a consumer of a digital wallet in accordance with an embodiment of the present invention.

FIG. 2 illustrates an exemplary client-server architecture and application environment for implementing a digital wallet in accordance with an embodiment of the present invention.

FIG. 3 illustrates selected aspects of the payment portion of the digital wallet server in accordance with an embodiment of the present invention.

FIG. 4 is a flow chart illustrating a setup procedure in accordance with an embodiment of the present invention.

FIG. 5 is a flowchart illustrating a method of setting spending limits in accordance with an embodiment of the present invention.

FIG. 6 is a flowchart illustrating a method using a temporary time-sensitive code.

FIG. 7 illustrates a method of allocating funds to an eCard and setting spending limits in accordance with an embodiment of the present invention.

### DETAILED DESCRIPTION

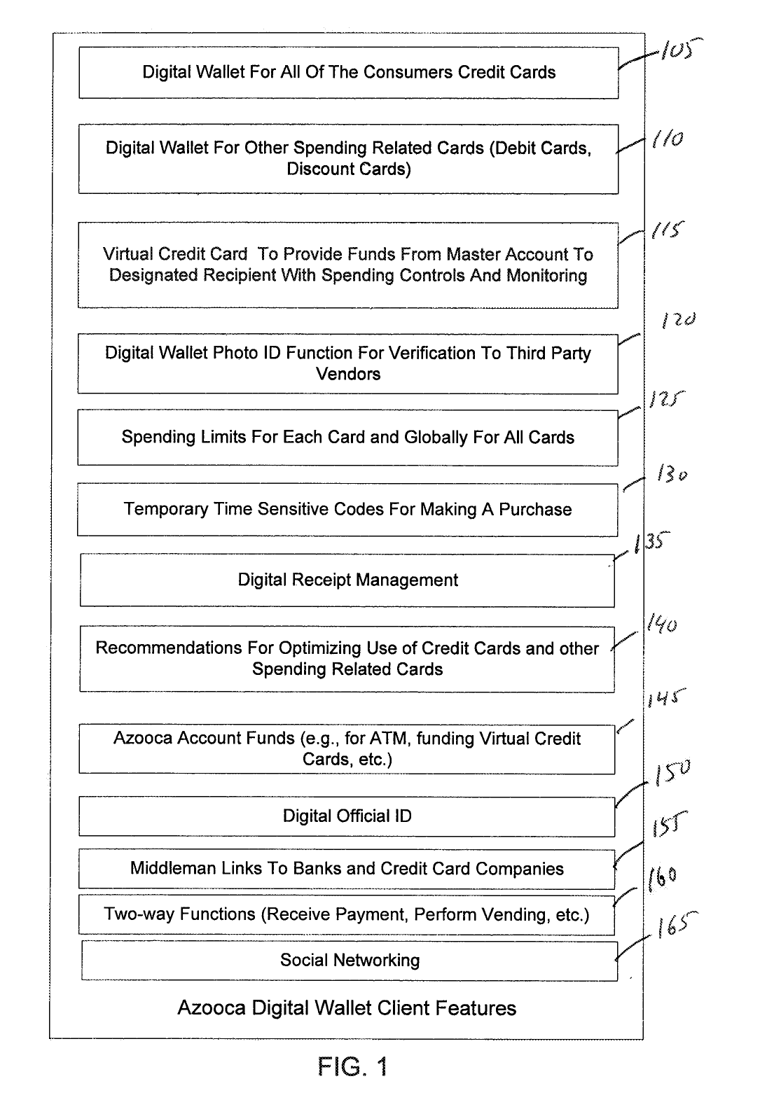

FIG. 1 illustrates an exemplary set of functions 100 provided to a user of a digital wallet solution, currently known by the company name “Azooca,” in accordance with one embodiment of the present invention. One aspect of the present invention is that the individual features of the Azooca solution that may be used, either separately or in combination, provide an improved digital wallet experience to a consumer.

In a preferred embodiment, the digital wallet is designed to provide a virtual wallet function in which a single mobile application supports the entire set of credit cards 105 that a consumer may have. That is, the consumer can implement any number of credit cards. Additionally, the digital wallet function may be extended to provide a complete replacement for the entire set of cards 110 that a consumer would ordinarily carry in a conventional physical wallet to make a purchase. In one embodiment, the virtual wallet function may be extended to include other types of spending cards, such as debit cards, discount cards, loyalty cards, etc.

Additionally, in one embodiment, a photo ID function 120 is provided. The photo ID function may be used to verify the identity of the consumer during a purchase and, thus, provide an additional layer of security to verify the identity of a purchaser, thus reducing the problems of credit card fraud and chargeback. For example, in the case of a suspicious purchase, a vendor may access the photo. Alternatively, a vendor will receive a point-of-sale photo of a customer from the digital wallet server for verification. In one implementation a vendor may hit a fraud alert button if the photo does not match the person at the point of sale. The fraud alert may, for example, be used to alert credit card companies of suspicious purchases and/or terminate a purchase, depending on implementation details. In one alternate embodiment, the vendor is provided the option of taking a photo of the consumer at the point of sale, sending the photo to the digital wallet server, and having the digital wallet server utilize image recognition to determine whether there is a potential fraud. For example, if a male consumer cuts off their beard, they might not resemble their photo to the naked eye of a vendor. In this example, the vendor may take a photo of the consumer at the point of sale and the facial recognition software at the digital wallet server then determines whether there is match. The use of a stored photo of the consumer as an additional security measure minimizes the potential for identity fraud, which benefits the consumer and merchant banks. Additionally, the use of a stored photo minimizes potential chargebacks should a consumer improperly allege identity fraud or non-receipt of a good or service.

With a conventional physical wallet, there are options to give cash or loan physical credit cards to others. One problem with digital wallets is that, in the past, they did not provide good options for virtualizing these functions. For the situation that a user desires to provide funds to a desired recipient (such as a friend or family member), a virtual credit card 115 (an eCard) may be generated that is linked to the user's account, and which provides monitoring and spending controls to the master account of the user.

Spending limits 125 may be provided for each card and globally for all cards. Thus, the user has additional control over their spending. Additionally, spending controls provide an additional sense of security to the consumer, because it provides an additional limit on potential loses should a malicious third party breach other security measures.

A temporary time sensitive code 130 may be generated by a digital wallet server and provided to the client device on demand, to improve security when a customer uses a client device to make a purchase from a physical vendor. At the point-of-sale, the vendor receives the temporary time sensitive code and sends it to the digital wallet server for verification. For example, if the code is visually displayed on the client device as a barcode or other type of visual code, the vendor can take a picture (or a scan) of the code, and the information is sent to the digital wallet server. The code becomes inoperative after a pre-set time period. The length of time that the code is valid may be selected to be comparatively short to further help the code from being captured by a malicious third party and used thereafter to make purchases. The code may include, for example, a user ID, location, credit card, date, and time. A time sensitive code portion has a limited duration. If the code is presented to a vendor visually, then the limited duration prevents a malicious third party from photographing the code and using it to make unauthorized purchases. Similarly, if the code is presented to a vendor wirelessly (using short range wireless transmission), the temporary time sensitive portion of the code prevents a malicious third party from using the code to make an authorized purchase.

Digital receipt management 135 is provided to store, sort, and organize digital receipts. Thus, the user is provided with an improved ability to manage credit card recipients. As an illustrative example, a consumer may make hundreds of credit card transactions each year using different cards. By providing the capability to store, sort, and organize digital receipts according to categories and folders, the consumer receives a new and improved ability to manage credit card receipts. Additionally, in one embodiment, a user is also provided with the option to digitally manage other types of receipts. In one implementation, a user can take a photograph and have the photographic information managed along with the digital receipts. For example, a consumer may photograph a paper receipt, and have the receipt managed as a digital receipt, either as an image of the paper receipt or by converting the image into text. Additionally, in one implementation, other types of attachments can also be managed with the digital receipts. For example, a user may be provided with the option to manage an email or email attachment (e.g., an online airline reservation) along with other digital receipts. As an illustrative example, if a consumer goes on a business trip, the digital receipt management permits digital receipts for credit card purchases to be managed, photographs to be taken for paper receipts of items bought with cash, and then managed as digital receipts, and also permits other information associated with the business trip (e.g., photos or attachments to show that expenses are within a company's guidelines) to be digitally managed along with the digital receipts.

In one embodiment, a user is provided with recommendations 140 on how to optimize the use of their credit cards. Consumers face many potential tradeoffs in the use of their credit cards and debit cards in order to optimize perks, rewards, and discounts. Additionally, the choice of a particular credit card may affect short term and long-term cash flow. For example, a reward card with higher reward points may also have higher interest rates. In one implementation, the user is provided with a recommendation for a preferred card to use at a given time to make a particular purchase.

In one embodiment, funds management 145 includes a capability to input digital funds into the digital wallet, and to make withdrawals from automatic teller machines (ATMs) or to make fund transfers, such as transfers to eCards.

In one embodiment, a digital official ID 150 verifies the identity of the user. The digital official ID 150 may, for example, include a verified photo of the user and other verification information. For example, the digital official ID 150 may be based on driver's license information input by a consumer, passport information input by the consumer, or from other forms of identification. Additionally, the verification may be supplemented with information obtained from online sources. For example, if a consumer initially inputs photographs of their driver's license, credit cards, and a personal photo, these information sources can be correlated, and also, optionally cross-checked with other online information sources, to generate a digital official ID verifying the identity of an individual. This permits the digital official ID 150 to be used as a substitute for conventional forms of photo ID. For example, the digital official ID 150 can be used to increase the level of trust between two individuals. The vendor, for example, may request the digital official ID 150 to verify the identity of the consumer. However, it is also possible that an individual consumer may want to verify the identity of another person in other situations, such as verifying the identity of a repairman coming to their home. In this example, the repairman has a digital official ID that is provided to the consumer.

Middleman links 155 to existing bank or credit card accounts 149 permits the digital wallet system to act as a middleman for managing payments. For example, a consumer may desire that their existing bank accounts and credit card account to be tied to the digital wallet server of the system. This permits a consumer to use the system as a middleman to manage payments, including managing payments to their account funds, as well as other payments.

In one embodiment, individual features are supported to provide two-way payment functions 160. That is, an individual consumer having a digital wallet may act as a buyer or a seller. In this embodiment, the digital wallet client device also supports vending functions. Thus, two individuals with respective digital wallets may buy or sell from each other. For example, if two individuals have booths at a flea market, they may be buyers and sellers of goods to each other. More generally, a variety of person-to-person payments are contemplated, which may also be used for other purposes besides commerce. For example, one friend may decide to reimburse another friend using their respective digital wallets. Consider the situation where an individual goes into a store and buys a food item for a friend. The friend may use their respective digital wallet to send a reimbursement to the person who paid for dinner.

A social networking module 165 supports linking to members of one or more social networks, such as family members, friends, business colleagues, club members, church groups, philanthropic organizations, gym acquaintances, or other social groups etc. Payments may be made within a social network, such as receiving a payment from a friend in the social network, or receiving a payment from a friend in the social network. As an illustrative example, an individual may order dinner for friends within the social network and arrangement for payment between friends.

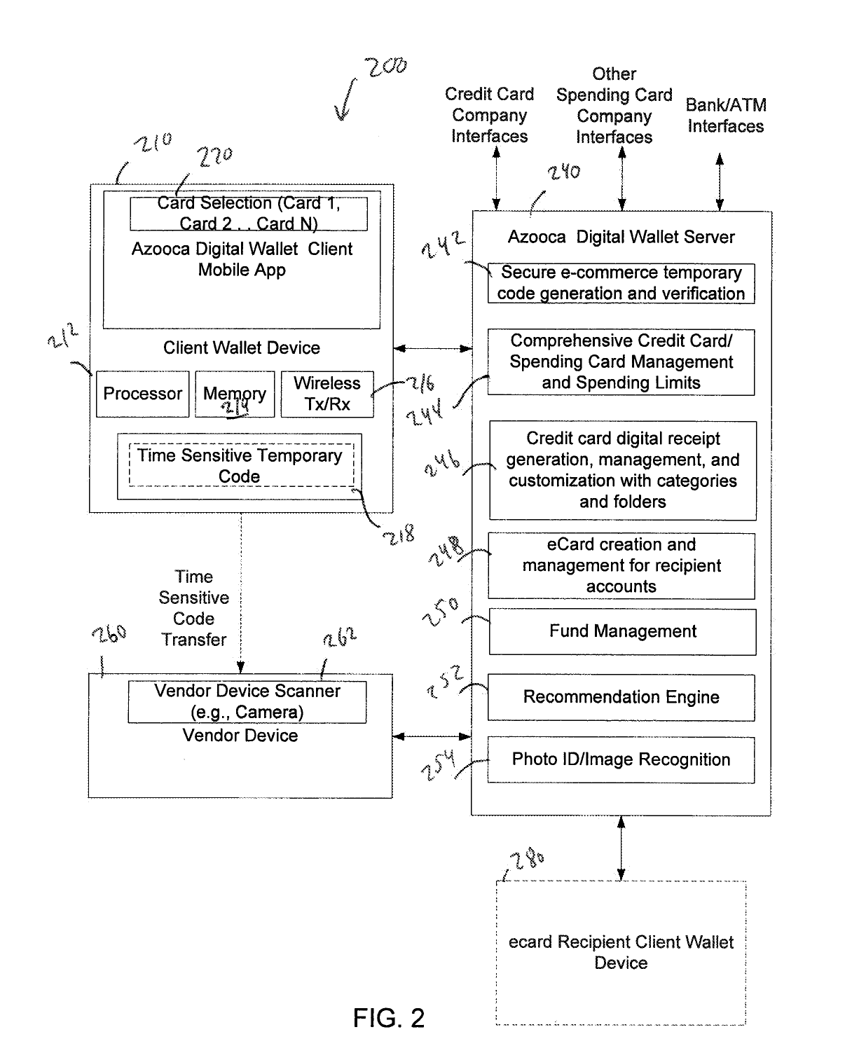

FIG. 2 illustrates an exemplary digital wallet system 200 and a use application environment in accordance with an embodiment of the present invention. Digital wallet system 200 is an exemplary system for practicing various novel methods, and it could understand that variations in digital wallet system 200 are contemplated.

An individual digital wallet client device 210 may be a smart phone or other mobile device. In a smart phone implementation, the digital wallet client device 210 includes hardware such as a processor 212, memory 214, a wireless transceiver 216, and a user interface that includes a display screen 218.

A client-side digital wallet mobile application 220 resides on the digital wallet client device 210. As would be understood by one of ordinary skill in the art, the client application 220 residing on the client device 210 may be implemented in different ways, depending on a design choice on whether the client application is a “thick client” or a “thin client.” Additionally, it would be understood that the functions of the client application 220 might also be implemented on a laptop or standalone computer during a setup phase, to perform a status check, or to make online purchases.

The mobile application 220 may be stored in memory 214 as computer readable instructions on the client wallet device 210 executable by processor 212. In one embodiment, the mobile application 220 is responsible for generating digital wallet user interfaces on the client device 210, and communicating with the digital wallet server 240.

In one embodiment, the digital wallet mobile application permits a user to manage a complete set of credit/debit cards. In one implementation, the digital wallet mobile application is also designed to provide a time-sensitive temporary code to a scanner 262 of vendor merchant device 260 visually via display screen 218. Alternatively, the time-sensitive temporary code can be provided by other means to the vendor merchant device 260, such as via a short-range wireless link or a manual input.

Digital wallet server 240 may be implemented as one or more secure servers accessible via wired and wireless Internet connections. Digital wallet server 240 has associated with it conventional hardware components such as processors, memory, database storage units, web servers, and interface elements for communication via wired and wireless communication over the Internet.

The digital wallet server 240 includes a set of software modules to support novel methods for using digital wallets. A secure e-commerce temporary code generation and verification module 242 is provided to enhance the security of using a digital wallet to purchase goods or services from a vendor. A comprehensive credit card management and spending limits module 244 is provided to manage spending limits on individual credit cards. A credit card digital receipt generation, management, and customization module 246 supports advanced receipt management features. An eCard creation and management module 248 supports the user of a master account generating an eCard for a recipient client wallet device 260 or account. A fund management module 150 manages aspects of managing money inflows and outflows from a user's account. A recommendation and notification engine 252 is included to provide recommendations on how to optimize the use of spending cards and provide notifications. It will also be understood that in alternate implementation that modules 242, 244, 246, 248, 250, and 252 may be used alone or in subsets.

Digital wallet server 240 may also include interfaces to credit card companies, spending card companies, and bank/ATM interfaces. That is, digital wallet server 240 has access to information associated with a user's credit cards and spending cards. The amount of interaction of the digital wallet server 240 in processing an order is a design implementation. The digital wallet server may act as an intermediary between a credit card company, the consumer, and a vendor, to process a purchase made with a credit card and generate a receipt for the client device. In one embodiment, the digital wallet server 240 provides a verification function (via a code) and provides a payment confirmation and digital receipt to a vendor. Alternatively, the digital wallet server may act in collaboration with the client device, a credit card company, and a vendor.

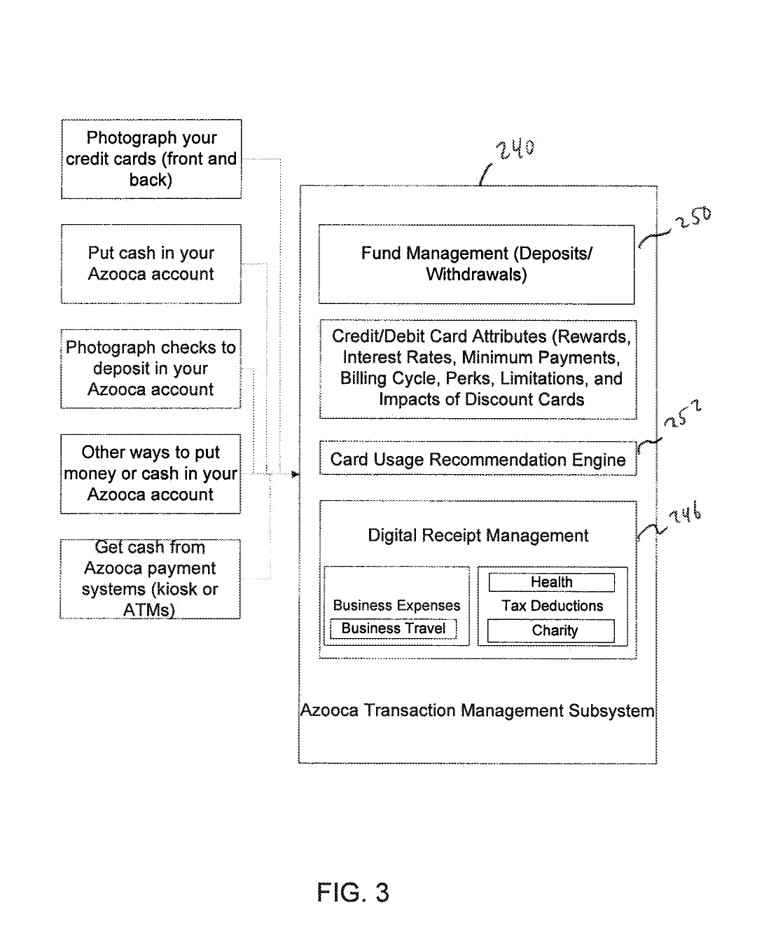

FIG. 3 is a block diagram illustrating in more detail a subset of aspects of features of server 240 related to payments, digital receipts, and security, in accordance with one embodiment of the present invention. A user is provided with options to put money into their account, and also to receive cash from payment systems. In one embodiment, a user may input photographs of credit cards and/or other types of cards (e.g., debit cards, discount cards, etc). In one embodiment, a user may file digital receipts according to categories and folders which the user may customize. Additionally, a default set of categories may be provided.

In the example illustrated in FIG. 3, a user has setup folders and subfolders for business expenses, business travel and tax deductions (e.g., health expenses and charitable deductions). A user interface is provided for a user to organize digital receipts into categories and folders in a digital receipt repository. The actual storage of the digital receipts in the repository may be performed in a database associated with the server 240. Alternately, the storage of the digital receipts may be performed at other storage locations. For example, a consumer may desire that the storage (or a subset thereof) also be mirrored or provided on another location or service.

For the case of repeat purchases from the same vendor, a default organization may be performed automatically. Default settings may also be setup during specific time intervals, such as during a business trip, to organize digital receipts for particular time periods.

Additionally, suggestions may be provided for a category by determining the type of business associated with a digital receipt. For example, information about the transaction (business name and address) may be referenced to look up information on business from a database or via the Internet. Alternatively, geo-location information obtained for a transaction may be stored and used to provide suggestions based on the location information. For example, a transaction occurring at the site of a church may be a charitable donation under certain circumstances.

Interfaces may be provided to download organized receipts or otherwise provide copies of one or more folders or subfolders. For example, folders of receipts may be downloaded to the user's computer, imported into other applications or programs, or selected folders provided to necessary parties. This facilitates actions such as requesting reimbursements for business expenses, preparing tax returns, and using a financial program to monitor monthly and yearly expenses for budgeting purposes.

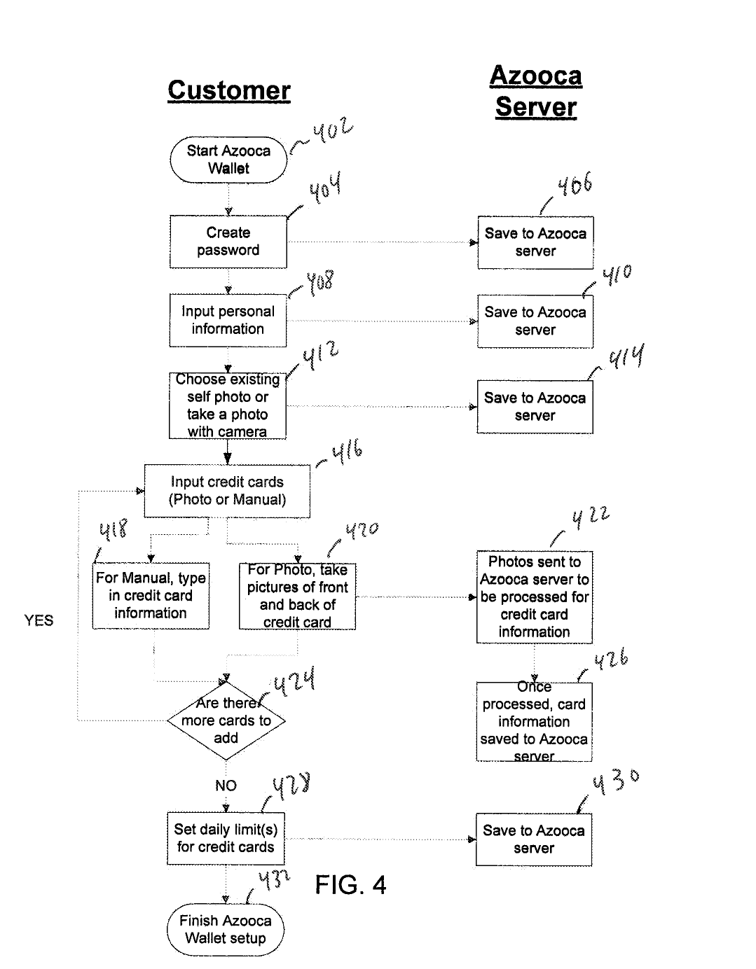

FIG. 4 is a flow chart illustrating customer setup in accordance with an embodiment of the present invention. A customer starts the digital wallet application in element 402. The customer creates a password in element 404, which is then saved on the digital wallet server 406. The customer inputs personal information 408 which is saved to the digital wallet server 410. The customer sends a photo of themselves 412 which is saved on the digital wallet server 414. The photo may, for example, be an existing photo or one taken by a camera of a client wallet device, such as by a smartphone camera. The user then inputs credit card information 416. This may be performed by the user manually inputting credit card information 418, or by the user sending photos of their credit cards 420 to the digital wallet server for image processing 422 of the photos to determine the credit card information. The user may be invited to enter information for additional cards (if any) until a determination is made in decision block 424 that there are no more cards to add. The processing information for a complete set of the user's cards is saved on the digital wallet server 426.

A user then sets daily limits for the credit cards 428 which are then saved on the digital wallet server 430. Additionally, other optional user preferences may be input by a user prior to finishing the wallet setup 432. For example, if the user desires to input information on other types of cards ordinarily carried in a physical wallet, then the process may be continued to input information for these cards similar to that done for credit cards.

A wide variety of different options and user preferences may be supported to account for all of the different potential purchasing options supported by the set of cards that a consumer typically carries in a conventional wallet.

In one embodiment, additional processing can be performed by the digital wallet server to identify attributes of the credit cards relevant to providing recommendations to a user on how to optimize credit card choices. When a consumer has a set of credit cards, they face choices on how the use of the credit cards will affect reward programs, perks, discounts, minimum payments and interest rates (if they cannot pay the entire amount on time). Additionally, some types of credit cards are dedicated to a limited set of purchase options (e.g., a credit card capable of being used at a single type of store, outlet, or service), or whether the card is a general purpose credit card. As illustrative examples, the processing can include identifying reward card attributes of individual cards (e.g., reward points and/or reward milestones), monthly interest rates per card, and maximum limits imposed by the credit card company. This information may be input by a user in a manual mode, or automatically obtained from credit card companies.

Moreover, some credit cards which are not “reward cards” still provide additional user benefits and perks. For example, some credit cards provide automatic car insurance if a rental car is paid by that card. Information on the benefits offered by individual credit cards may also be either manually or automatically collected to provide recommendations on which credit card to use. As an illustrative example, if a user is at a rental car company, a recommendation may be provided on which credit card minimizes the insurance cost for renting a car. Additionally, some credit cards provide discounts for purchases made at specific stores.

In one embodiment, the system is designed to provide recommendations on how to best use a credit card in view of other potential benefits or rewards from other sources. Additional extensions may include acquiring information on cards which are not credit cards, but which might result in a discount for a credit card payment. For example, information on discount cards or loyalty cards that might reduce a payment may also optionally be collected. Examples include auto club cards (which may reduce payments at motels and car repair shops), prescription discount cards, restaurant discount cards (which may affect meal prices), elderly discount cards (e.g., American Association of Retired People), etc.

Additionally, it will be understood that the system can be expanded to handle limited purpose uses of credit or debit cards. As an example, some types of employee benefit programs include spending accounts funded either by a company or by the employee. As one example, some types of health benefits are payable by a debit or credit card, but impose limits on the types and amounts of expenditures. Additionally, some types of government benefits are payable by a debit or credit card. These spending accounts may be implemented as debit cards or using credit cards. Attributes of a particular spending program can be collected (e.g., which expenses may be applied to a card and any spending limits). As an illustrative example, a user may be provided a recommendation on which of their cards to use, which includes suggestions for limited purpose cards.

Optimization of the use of a set of credit cards, discount cards, and limited purpose cards may also include timing considerations. For example, different credit card companies may be on different billing cycles and/or have different policies on when late payments begin. Information on attributes related to such timing considerations may also be manually input, or automatically acquired to provide recommendations on how a user can best manage cash flow. For example, even if two cards are otherwise equal, their respective billing cycles may be offset from one another. This may favor one card over another in certain circumstances, such as using a credit card in which the billing cycle occurs in a more favorable time of the month for the consumer to postpone making payments.

Many mobile devices include geo-location features. In one embodiment, an option is provided to provide geo-location information from the client device for use in providing recommendations. For example, global positioning system (GPS) information from a smart phone may be acquired and provided to the digital wallet server to aid in providing recommendations based on location (e.g., a recommendation based on being at a gas station may be different than a recommendation at a food store). Additionally, information on location may be used to base recommendations by, for example, eliminating cards which are not accepted at a particular location.

Historical use patterns may also be acquired to provide recommendations on use. For example, if a customer tends to use certain cards in a particular way, this may reveal a preference which can be set as a default or a default ranking of credit cards in making a recommendation for particular fact patterns.

The system may also support debit cards and provide recommendations based on funds in debit cards. For example, a custom debit card may be supported by the digital wallet server, in which case a user would setup a debit card. Alternately, a bank may report on funds available in a debit card to the digital wallet server, in which case a user may be requested to provide information on the debit card. As an illustrative example, discounts are sometimes provided whenever a consumer uses a debit card instead of a credit card due to the lower processing costs. Additionally, some stores offer additional discounts and perks when the store's debit card is used at the store. These additional discounts and perks may favor recommending a debit card instead of a credit card in certain circumstances.

In one embodiment, recommendations are provided in real-time when a user contemplates a purchase. However, more generally, the system may analyze historical trends and provide alerts or periodic recommendations to provide advice for optimizing the use of spending cards in future purchases. Additionally, in one embodiment, a user can input preferences regarding the manner in which recommendations are to be made and the type of recommendations.

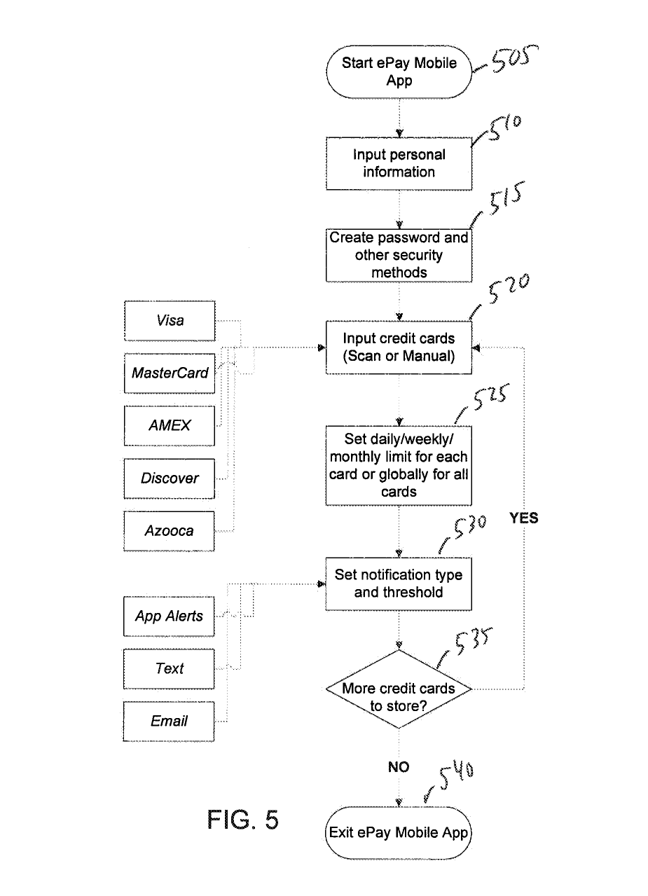

FIG. 5 illustrates an exemplary spending limit method in accordance with an embodiment of the present invention. A customer starts the mobile app 505 and inputs personal information 510. The user creates a password and any other optional security methods 515. The user inputs credit card information 520. The user sets spending limits for individual cards or globally for all cards 525. The spending limits may be set for various time periods, such as daily, weekly, or monthly. The user may set notification types and threshold 530, such as application alerts, text alerts, or email alerts. The process of setting limits and notification is continued until all of the user's credit cards have been input 535. The process is then exited 540. Spending limits may also be setup for other types of cards, such as debit cards. It will also be understood that spending limits are optional. For example, a default can be no spending limit unless a user otherwise selects a particular spending limit.

Spending limits may be static limits, dynamic limits, or combinations of static and dynamic limits. Static limits are limits set to be lower than those of credit card or debit card company. For example, a credit card may have a $5000 credit limit whereas a consumer may want to set a daily limit of $300 to better manage funds and/or to provide an additional layer of fraud protection.

While a static spending limits is a preferred embodiment, it will also be understood that dynamic spending limits are also possible. A dynamic limit may include some additional variable as a factor to increase or decrease the limits. For example, additional reporting information on the financial situation of the customer could be used to adjust the limits, such as reporting information received from the customer's bank account, the funds in a debit account, or total credit card debt. Alternatively, the spending limits could be varied based on time or be reconfigured by the user as their needs change. For example, a customer might want to change the spending limits prior to heading out on vacation.

Security is an important concern in using a digital wallet. When a consumer uses a digital wallet to make a purchase at a physical location, such as a store, it is desirable to perform a user identification step. This is necessary to form the associations between the user ID and the order to direct payments to the vendor. However, in the prior art, many types of identification processes resulted in a static identification code being transferred in the open (e.g., as a visual QR code sent from a smartphone) that was capable of interception by malicious third parties. Additionally, the problems of interception by third parties is compounded if a digital wallet is used in a crowded area having a lot of human traffic, such as a coffee shop, or an outdoor location, such as a flea market.

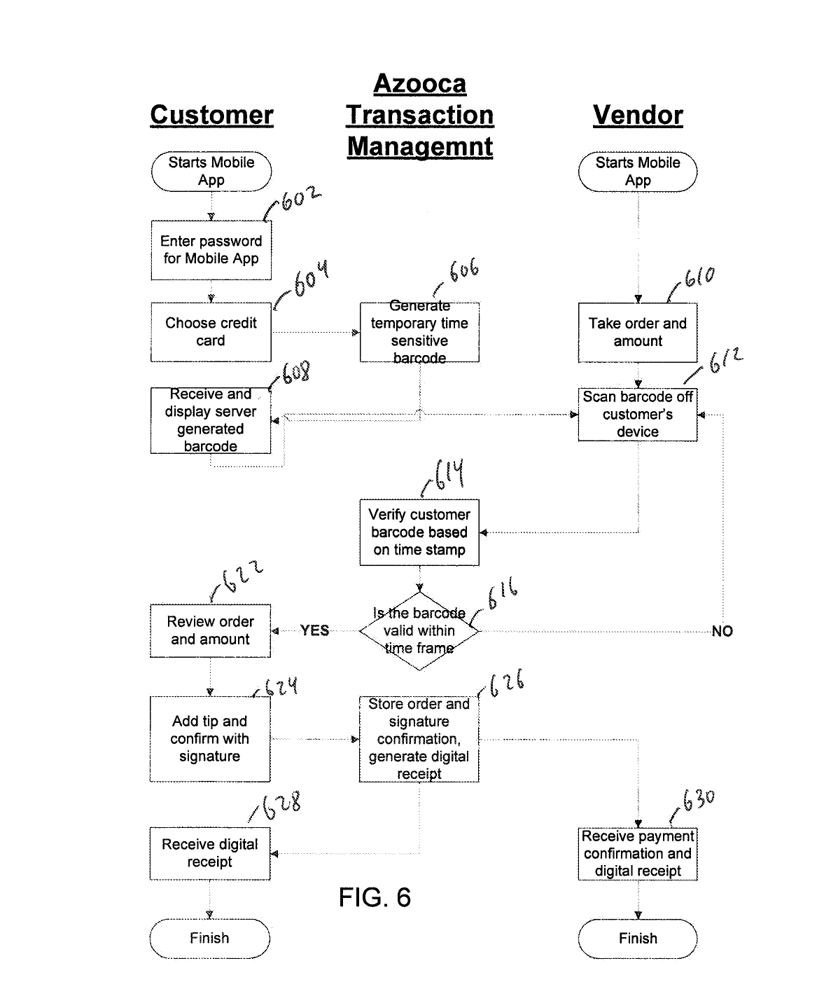

FIG. 6 is a flowchart illustrating a method of improving security of transactions between a customer and a vendor using time sensitive codes in accordance with an embodiment of the present invention. In this example, both the customer and the vendor have access to an Azooca mobile application. In one embodiment, the vendor-portion of the mobile application runs on the vendor's mobile device. In another embodiment, the vendor portion of the mobile application runs on another vendor device, such as a standalone computing or payment device.

A customer starts a mobile application and enters a password 602 and chooses a credit card 604. The digital wallet server generates a temporary time sensitive code 606 which is received by the customer's mobile device. In one embodiment, the temporary time sensitive code is displayed as a visual code on the display of the user's device. As an illustrative example, the visual code may be a barcode. However, more generally, it could be any type of code that identifies the customer, and in which a portion of the code has temporary, time-sensitive aspect.

The vendor takes an order and amount 610 and scans the code from the customer's device 612. For example, in one embodiment, vendor takes a picture of a visual code displayed on the customer's device. The vendor provides the scanned code to the digital wallet server to identify and verify the customer code based at least, in part, on a time stamp 614. A determination is made whether the code is valid within a given time frame 616. If the code is not valid within a pre-selected time frame, then the vendor is notified 618 that the code is invalid. If the code is valid, then a notification is provided to the customer (and may also optionally to the vendor) 620. The customer reviews the order and amount 622 and completes the order by confirming it (e.g., with a signature or other authorization) 624, and includes any optional tip.

In one embodiment, the digital wallet server receives the signature/authorization, stores the order and signature confirmation, and generates a digital receipt. The customer is provided a copy of the digital receipt 628. The vendor is also provided a copy of the digital receipt 630. Additionally, the vendor may be provided payment, either directly or indirectly.

In the example of FIG. 6, the vendor portion of the mobile application may be implemented as a separate standalone module provided to a vendor. Alternatively, it may be bundled with the entire mobile application such that each client device running the mobile device is also capable of the vending functions illustrated in FIG. 6. As an illustrative example, many individuals engage in entrepreneurial activities on a part-time basis (e.g., flea markets, garage sales, piano teachers, etc.). The ability to provide a comprehensive digital wallet solution that also supports a consumer also vending goods or services is, thus, advantageous in many use scenarios.

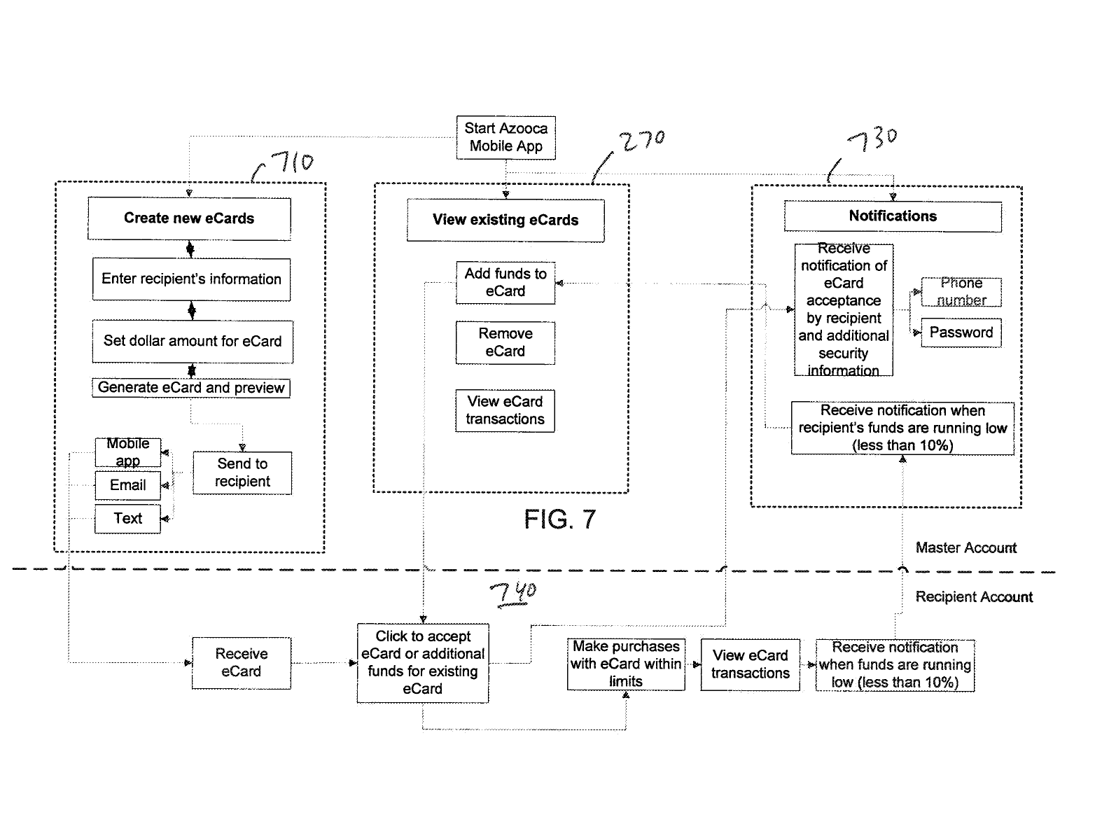

FIG. 7 illustrates aspects of eCard creation, management, and fund allocation in accordance with an embodiment of the present invention. An eCard is a virtual credit/debit card created and managed from a master account and used to provide a virtual credit to a recipient account. As an illustrative example, a parent may setup an eCard for a child going to college. As another illustrative example, a homeowner may setup an ecard for a house cleaner to buy cleaning supplies. A user creates 710 a new ecard by inputting information such as the recipient's information, setting a funded amount for the eCard (dollars if the recipient is in the United States), previewing the eCard, and sending it to the recipient. The funding can be an initial lump sum; alternatively, a user may also setup a schedule of deposits (e.g., monthly funding amount to be automatically provided from a bank account).

The eCard can be unrestricted, meaning that the recipient can use the funds for any purpose, up to the maximum amount of available funds. Alternatively, limits can be set at the master account for the amount that can be spent in a given time period, such as a daily, weekly, or monthly limit.

The user can view existing eCards 720. The user of the master account can add funds, remove eCards, and also view eCard transactions made by the recipient.

Notifications 730 may be provided of acceptance by a recipient of an eCard along with additional security information, such as a phone number or International Mobile Station Equipment Identity (IMEI); to provide verification information to confirm that the intended recipient actually received the eCard and/or is using the card. Notification may also be provided when the recipient's funds are running below a pre-set threshold.

At the recipient's side 740, the recipient receives an eCard, clicks to accept the eCard or accept additional funds for an existing card. The recipient can then make purchases with the eCard within the limits, view eCard transactions, and receive notifications when funds reach specified thresholds.

While the invention has been described in conjunction with specific embodiments, it will be understood that it is not intended to limit the invention to the described embodiments.

On the contrary, it is intended to cover alternatives, modifications, and equivalents as may be included within the spirit and scope of the invention as defined by the appended claims. The present invention may be practiced without some or all of these specific details. In addition, well known features may not have been described in detail to avoid unnecessarily obscuring the invention. In accordance with the present invention, the components, process steps, and/or data structures may be implemented using various types of operating systems, programming languages, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein. The present invention may also be tangibly embodied as a set of computer instructions stored on a computer readable medium, such as a memory device.

1. A method of providing a digital wallet function at a client device, comprising:
selecting, via a user interface on the client device, a credit card to make a payment for a transaction from a set of credit cards for the user;
paying for the transaction via the selected credit card; and
receiving a digital receipt for the transaction.

2. The method of claim 1, further comprising sending a photo of the user to a digital wallet server for use in verifying the identity of the user.

3. The method of claim 1, further comprising setting spending limits for each credit card of the user.

4. The method of claim 1, further comprising receiving a recommendation for which credit card to pay a transaction.

5. The method of claim 1, further comprising sending funding information and recipient information to generate a virtual credit card for a recipient.

6. The method of claim 5, wherein the funding information includes a spending limit.

7. The method of claim 6, further comprising receiving access to digital receipts for purchases made by the recipient.

8. The method of claim 6, further comprising receiving a notification when the available funds have decreased to a threshold level relative to the spending limit.

9. The method of claim 6, further comprising:
receiving a time-sensitive temporary code from a digital wallet server; and
sending the time-sensitive temporary code to a vendor device.

10. The method of claim 9, wherein the time-sensitive temporary code is displayed on a display screen of the client device.

11. The method of claim 6, further comprising organizing digital receipts in into customizable categories.

12. An apparatus, comprising:
a mobile client device including a processor, a memory, and a user display; and
a digital wallet client application including a user interface to:
select a credit card to make a payment for a transaction from a set of credit cards for the user;
pay for the transaction via the selected credit card; and
receive a digital receipt for the transaction.

13. The apparatus of claim 12, wherein the digital wallet application sends a photo of the user to a digital wallet server for use in verifying the identity of the user.

14. The apparatus of claim 12, wherein the digital wallet application sets spending limits for each credit card of the user.

15. The apparatus of claim 12, further comprising the digital wallet application displaying a recommendation for which credit card to pay a transaction.

16. The apparatus of claim 12, further comprising the digital wallet application providing funding information and recipient information to a digital wallet server to generate a virtual credit card for a recipient.

17. The apparatus of claim 16, wherein the funding information includes a spending limit.

18. The apparatus of claim 16, further comprising the digital wallet application receiving access to digital receipts for purchases made by the recipient.

19. The apparatus of claim 16, further comprising the digital wallet application receiving a notification when the available funds have decreased to a threshold level relative to the spending limit.

20. The apparatus of claim 16, wherein the digital wallet application:
receives a time-sensitive temporary code from a digital wallet server; and
sends the time-sensitive temporary code to a vendor device.

21. The apparatus of claim 20, wherein the time-sensitive temporary code is displayed on a display screen of the mobile client device.

22. The apparatus of claim 16, further comprising the digital wallet application generating a display of digital receipts stored on a digital wallet service, wherein the digital receipts are organized in into customizable categories.

23. A non-transitory computer readable storage medium comprising computer readable instructions that when executed on a processor, implement a method comprising:
selecting, via a user interface on the client device, a credit card to make a payment for a transaction from a set of credit cards for the user;
paying for the transaction via the selected credit card; and
receiving a digital receipt for the transaction.
